(19) United States
(12) Patent Application Publication
(10) Pub. No.: US 2018/0329521 A1
(43) Pub. Date: Nov. 15, 2018

(54) APPLICATION PROGRAM MODE BASED ON DEVICE ORIENTATION

(71) Applicant: Microsoft Technology Licensing, LLC, Redmond, WA (US)

(72) Inventors: John Benjamin HESKETH, Kirkland, WA (US); Mario Emmanuel MALTEZOS, Redmond, WA (US); Kenneth Liam KIEMELE, Redmond, WA (US); Aaron D. KRAUSS, Snoqualmie, WA (US); Charles W. LAPP, III, Issaquah, WA (US); Charlene JEUNE, Redmond, WA (US); Bryant Daniel HAWTHORNE, Duvall, WA (US); Jeffrey R. SIPKO, Kirkland, WA (US)

(73) Assignee: Microsoft Technology Licensing, LLC, Redmond, WA (US)

(21) Appl. No.: 15/635,107

(22) Filed: Jun. 27, 2017

Related U.S. Application Data
(60) Provisional application No. 62/506,511, filed on May 15, 2017.

(51) Int. Cl. G06F 3/0346; G06F 1/16; G06F 3/0482; H04L 29/06; H04N 7/15

(52) U.S. Cl. CPC G06F 3/0346; G06F 1/1618; G06F 2203/04803; H04L 65/403; H04N 7/15; G06F 3/0482

(57) ABSTRACT

To address the issues of presentation display, a mobile computing device is provided. The mobile computing device may include a two-part housing coupled by a hinge, with first and second parts that include first and second displays, respectively. The displays may rotate around the hinge throughout a plurality of angular orientations. The mobile computing device may include an angle sensor, one or more inertial measurement units, and a processor mounted in the housing. The angle sensor may detect a relative angular orientation of the first and second displays, and the inertial measurement unit may measure a spatial orientation of the device, which together define a posture of the device. The processor may be configured to execute an application program and, based on the posture of the device, select a display mode of the application program that defines a layout of graphical user interface elements displayed on the displays.

### CROSS REFERENCE TO RELATED APPLICATIONS

This application claims priority to U.S. Provisional Patent Application No. 62/506,511, filed on May 15, 2017, the entirety of which is hereby incorporated herein by reference.

### BACKGROUND

Mobile computing devices allow users to conveniently view and share images, application programs, and digital content, as well as communicate through live video feed. While such devices are a convenient platform for displaying a photo or video to one or two people, using a presentation application program on the mobile computing device can be challenging in several ways. When displaying the presentation on the device, the user does not have access to presentation assistance, such as preview slides or notes. When creating or editing a presentation on a mobile computing device, the size of the display limits the ability of the user to make edits or read notes while viewing the display. Sharing content and taking notes on a mobile computing device during a video conference is similarly constrained, and the user must switch between the video conference and other content.

### SUMMARY

To address the above issues, a mobile computing device is provided. The mobile computing device may include a housing having a first part and a second part coupled by a hinge. The first part may include a first display and the second part may include a second display, and the hinge may be configured to permit the first and second displays to rotate between angular orientations. The mobile computing device may further comprise an angle sensor, one or more inertial measurement units, and a processor mounted in the housing. The angle sensor may be configured to detect a relative angular orientation of the first and second parts of the housing, and the inertial measurement units may be configured to measure a spatial orientation of the device. The processor may be configured to execute an application program, and a mode of the application program may be changed based on the angular orientation of the first and second parts of the housing and the spatial orientation of the device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic of an example mobile computing device of the present description.

FIG. 2A shows an example of two displays arranged in an open, side-by-side orientation for the mobile computing device of FIG. 1.

FIG. 2B shows an example of two displays of the mobile computing device of FIG. 1 arranged in an example back-to-back orientation in which the displays are in a reflex position.

FIG. 2C shows an example of two displays of the mobile computing device of FIG. 1 arranged in an example back-to-back orientation in which the displays are in a fully open position.

FIG. 2D shows an example of two displays of the mobile computing device of FIG. 1 arranged in a face-to-face orientation in which the displays are in a fully closed position.

FIG. 3 shows the mobile computing device of FIG. 1 with the first and second displays arranged in top-to-bottom orientation during a presentation application program.

FIG. 4 shows the mobile computing device of FIG. 1 with the first and second displays arranged in side-by-side orientation during a presentation application program.

FIG. 5 shows the mobile computing device of FIG. 1 with the first and second displays arranged in a back-to-back orientation during a presentation application program.

FIG. 6 shows the mobile computing device of FIG. 1 with the first and second displays arranged in a top-to-bottom orientation during a video conference application program.

FIG. 7 shows a flowchart of a method for displaying an application program on a mobile computing device based on the angular and spatial orientations, according to one implementation of the present disclosure.

FIG. 8 shows an example computing system according to one implementation of the present disclosure.

### DETAILED DESCRIPTION

The inventors of the subject application have discovered that using a mobile computing device for executing a content creation application program is constrained by the available display space and configuration of the device. For example, when creating and editing a file in a presentation application program, the user may find it difficult and frustrating to view a preview of the presentation and the editing module at the same time. Changing the orientation of a mobile computing device can increase or decrease the size of the displayed content; however, this may result in either no space for editing controls or the displayed presentation being too small to accurately edit. This situation may lead to flipping back and forth between the editing module and the presentation, which is time-consuming and error-prone. When displaying a presentation to an audience, the user is left without an area for editing or viewing presentation notes. Similarly, when using a mobile computing device to conduct a video conference on a mobile computing device, it is not possible for a user to simultaneously view, edit, or share content with a colleague while maintaining visual contact with other members of the video conference on the display. Switching between the video conference and other content may be confusing and distracting for the user and other members involved in the video conference.

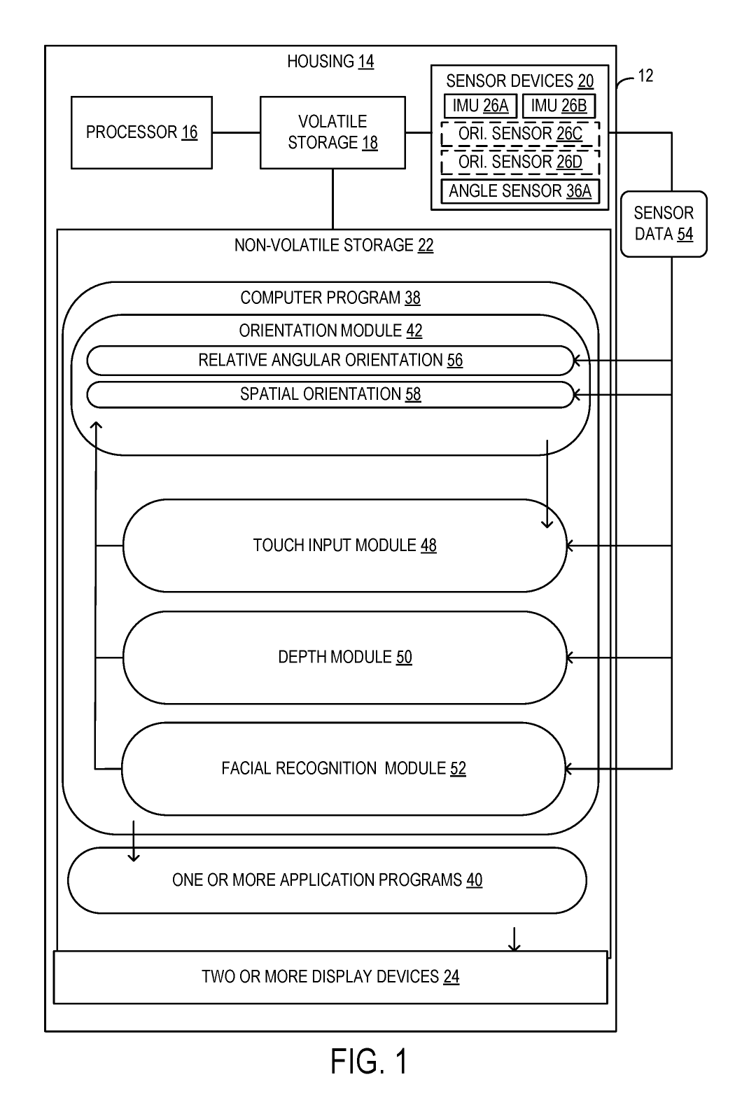

To address the issued presented above, a mobile computing device 12 is provided in FIG. 1. The mobile computing device 12 may include a housing 14, which, for example, may take the form of a casing surrounding internal electronics and providing structure for displays, sensors, speakers, buttons, etc. The housing 14 is configured to include a processor 16, volatile storage device 18, sensor devices 20, non-volatile storage device 22, and two or more display devices 24. The mobile computing device 12 may, for example, take the form of a smart phone device. In another example, the mobile computing device 12 may take other suitable forms, such as a tablet computing device, a wrist mounted computing device, etc.

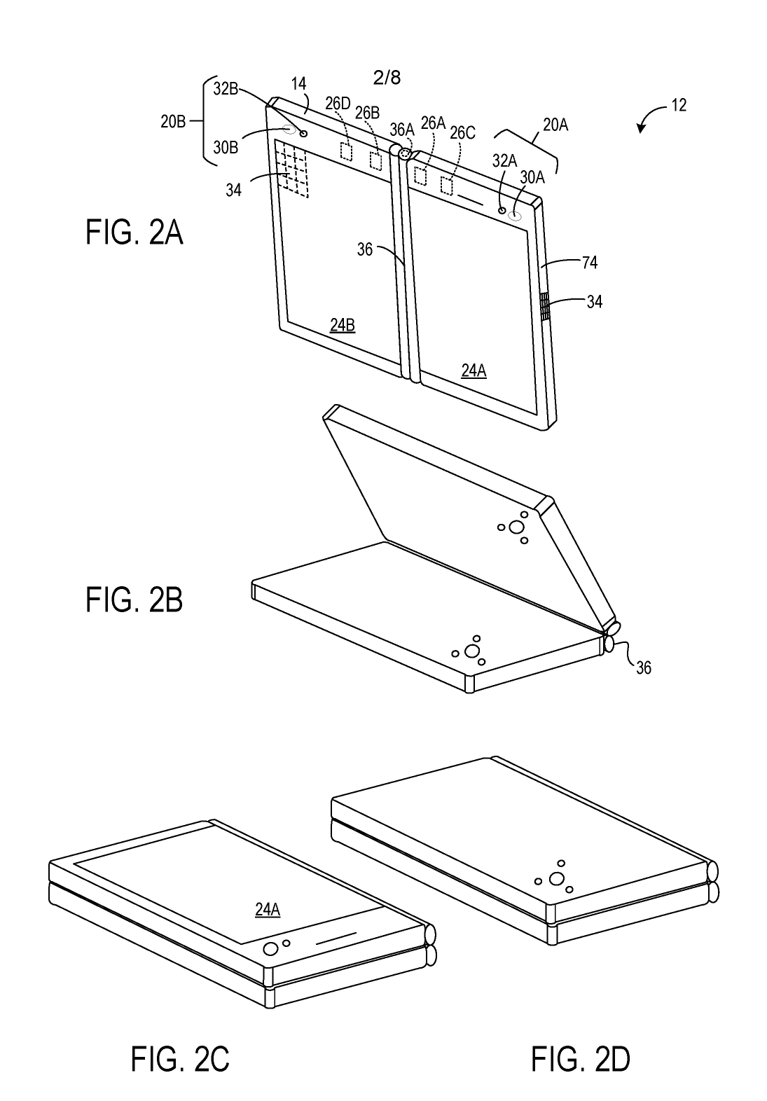

Turning to FIG. 2A, an example mobile computing device 12 is illustrated. As shown, the example mobile computing device 12 includes a housing 14. The housing 14 may have a first part 14A and a second part 14B coupled by a hinge 36. The first part 14A may include a first display 24A, and the second part 14B may include a second display 24B. The hinge 36 may be configured to permit the first and second displays 24A, 24B to rotate between angular orientations from a face-to-face angular orientation to a back-to-back angular orientation. A relative angular displacement may be measured between an emissive side of each of the first and second displays 24A and 24B. In one implementation, the face-to-face angular orientation is defined to have an angular displacement as measured from display to display of between 0 degrees and a first threshold, such as 90 degrees, an open angular orientation is defined to be between the first threshold and a second threshold, such as 90 degrees and 270 degrees, and a back-to-back orientation is defined to be between the second threshold and a third threshold, such as 270 degrees and 360 degrees. Alternatively, an implementation in which the open angular orientation is not used to trigger behavior may be provided, and in this implementation, the face-to-face angular orientation may be defined to be between 0 degrees and an intermediate threshold, such as 180 degrees, and the back-to-back angular orientation may be defined to be between the intermediate threshold and 360 degrees. In either of these implementations, when tighter ranges are desired, the face-to-face angular orientation may be defined to be between 0 degrees and a first threshold of 60 degrees, or more narrowly to be between 0 degrees and a first threshold of 30 degrees, and the back-to-back angular orientation may be defined to be between a second threshold of 300 degrees and 360 degrees, or more narrowly to be between a second threshold of 330 degrees and 360 degrees. The 0 degree position may be referred to as fully closed in the fully face-to-face angular orientation and the 360 degree position may be referred to as fully open in the back-to-back angular orientation. In implementations that do not use a double hinge and which are not able to rotate a full 360 degrees, fully open and/or fully closed may be greater than 0 degrees and less than 360 degrees.

The mobile computing device 12 may further include an angle sensor 36A, one or more orientation sensors in the form of inertial measurement units 26, and a processor 16 mounted in the housing. The angle sensor 36A may be configured to detect a relative angular orientation 56 of the first and second displays 24A, 24B of the housing 14, and the one or more inertial measurement units 26 may be configured to measure a spatial orientation 58 of the device 12. The processor 16 may be configured to execute an application program 40. A user may arrange the angular orientation of the first and second displays 24A, 24B of the housing 14 and the spatial orientation of the device to define a posture of the device 12. Based upon the posture of the device 12, the processor 16 may be configured to select a display mode of the application program 40 from a plurality of display modes. Each of the display modes may define a layout of graphical user interface elements of the application program 40 that are displayed on the first and second displays 24A, 24B.

The mode of the application program 40 may include displaying graphical user elements corresponding to a first view of the application program 40 on the first display 24A, and displaying graphical user elements corresponding to a second view of the application program 40 on the second display 24B. The device 12 may include an application programming interface (API) that determines a posture-specific display mode selection of the application program 40. For example, the application program 40 may query the API, which in turn may access the angle sensor 36A via orientation module 42 executed by the processor 16 and/or the inertial measurement units 26A, 26B to determine a posture of the device 12, and then return this information to the application program 40, for the application program 40 to select a display mode according to the posture of the device 12.

In this way, the posture of the device 12 may determine the content of the application program 40 that is displayed on each of the first and second displays 24A, 24B. For example and as discussed in detail below, a preview of application data may be displayed on the first display 24A while an editing module 62 for the application data may be displayed on the second display 24B. In some examples, only the spatial orientation or only the angular orientation may define the posture of the device 12. This aspect allows a user to quickly and conveniently switch between different modes available in an application program 40, such as present or edit, simply by changing the posture of the device 12.

As discussed above, the housing 14 may be configured to internally house various electronic components of the example mobile computing device 12, including the processor 16, volatile storage device 18, and non-volatile storage device 22. Additionally, the housing 14 may provide structural support for the display devices 24 and the sensor devices 20. The sensor devices 20 may include a plurality of different sensors, such as, for example, angle sensor 36A and inertial measurement units 26A and 26B. The sensor devices may also include forward facing cameras 30A and 30B, depth cameras 32A and 32B, etc. The cameras are not particularly limited and may comprise a time of flight (TOF) three-dimensional camera, a stereoscopic camera, and/or picture cameras. The inertial measurement units 26A and 26B may include accelerometers, gyroscopes, and possibly magnometers configured to measure the position of the mobile computing device 12 in six degrees of freedom, namely x, y, z, pitch, roll and yaw, as well as accelerations and rotational velocities, so as to track the rotational and translational motion of the mobile computing device 12. The sensor devices 20 may also include a capacitive touch sensor 34, such as a capacitive array that is integrated with each of the two or more display devices 24. In another example, the sensor devices 20 may include camera-in-pixel sensors that are integrated with each of the two or more display devices 24. It will be appreciated that the examples listed above are exemplary, and that other types of sensors not specifically mentioned above may also be included in the sensor devices 20 of the mobile computing device 12. In the illustrated example, the sensor devices 20 include two or more inertial measurement units 26A and 26B that are contained by the housing 14. The sensor devices 20 may further include forward facing cameras 30A and 30B. In one example, the forward facing cameras 30A and 30B include RGB cameras. However, it will be appreciated that other types of cameras may also be included in the forward facing cameras 30. In this example, forward facing is a direction of the camera's associated display device. Thus, in the example of FIG. 2A, as the first and second displays 24A, 24B are facing the same direction, both of the forward facing cameras 30A, 30B are also facing the same direction. The sensor devices 20 further include depth cameras 32A, 32B.

As shown, the sensor devices 20 may also include capacitive touch sensors 34 that are integrated with the first and second displays 24A, 24B, as well as other additional displays. In the illustrated embodiment, the capacitive touch sensors 34 include a capacitive grid configured to sense changes in capacitance caused by objects on or near the display devices, such as a user's finger, hand, stylus, etc. In one embodiment, the capacitive touch sensors 34 may also be included on one or more sides of the mobile computing device 12. For example, the capacitive touch sensors 34 may be additionally integrated into the sides of the housing 14 of the mobile computing device 12. While the capacitive touch sensors 34 are illustrated in a capacitive grid configuration, it will be appreciated that other types of capacitive touch sensors and configurations may also be used, such as, for example, a capacitive diamond configuration. In other examples, the sensor devices 20 may include camera-in-pixel devices integrated with each display device including the first and second displays 24A, 24B. It will be appreciated that the sensor devices 20 may include other sensors not illustrated in FIG. 2A.

In the example mobile computing device 12 illustrated in FIG. 2A, the first and second displays 24A, 24B are movable relative to each other. As shown, the example mobile computing device 12 includes a housing 14 including the processor 16, the inertial measurement units 26A and 26B, and the two or more display devices 24, the housing including a hinge 36 between the first and second displays 24A, 24B, the hinge 36 being configured to permit the first and second displays 24A, 24B to rotate between angular orientations from a face-to-face angular orientation to a back-to-back angular orientation. As discussed above, an angle sensor 36A may be included in the hinge 36 to detect a relative angular orientation 56 of the first and second displays 24A, 24B of the housing 14.

Now turning to FIG. 2B, the hinge 36 permits the first and second displays 24A, 24B to rotate relative to one another such that an angle between the first and second displays 24A, 24B can be decreased or increased by the user via applying suitable force to the housing 14 of the mobile computing device 12. As shown in FIG. 2B, the first and second displays 24A, 24B may be rotated until the first and second displays 24A, 24B reach a back-to-back angular orientation as shown in FIG. 2C.

As illustrated in FIG. 2C, while in an angular orientation where the first and second displays 24A, 24B are in a fully open back-to-back angular orientation, the first and second displays 24A, 24B face away from each other. Thus, while using the mobile computing device 12, the user may only be able to view one of the display devices of the first and second displays 24A, 24B at a time. Additionally, while in a back-to-back angular orientation, sensor packages 20A and 20B of the sensor devices 20, which may each include forward facing cameras 30A and 30B, and depth cameras 32A and 32B, also face in the same direction as their respective display device, and thus also face away from each other.

As shown in FIG. 2D, the angular orientation between the first and second displays 24A, 24B may also rotate to a fully closed face-to-face orientation where the pair of display devices face each other. Such an angular orientation may help protect the screens of the display devices.

Turning back to FIG. 1, the processor 16 is configured to execute a computer program, which, for example, may be an operating system or control program for the mobile computing device, and one or more application programs 40 stored on the non-volatile storage device 22, and to enact various control processes described herein. In some examples, the processor 16, volatile storage device 18, and non-volatile storage device 22 are included in a System-On-Chip configuration.

The computer program 38 executed by the processor 16 includes an orientation module 42, a touch input module 48, a depth module 50, and a face recognition module 52. As shown in FIG. 1 with reference to FIG. 2A, the orientation module 42 is configured to receive sensor data 54 from the sensor devices 20. Based on the sensor data 54, the orientation module 42 is configured to detect a relative angular orientation 56 between the first and second displays 24A, 24B and a spatial orientation 58 of the device 12. As discussed previously, the angular orientation of the first and second displays 24A, 24B of the housing 14 may be in a range from a face-to-face angular orientation to a back-to-back angular orientation.

The orientation module 42 may be configured to determine the relative angular orientation 56 and the spatial orientation 58 of the device 12 based on different types of sensor data 54. In one embodiment, the sensor data 54 may include inertial measurement unit data received via the inertial measurement units 26A and 26B. As discussed above, the inertial measurement units 26A and 26B may be configured to measure the position of the mobile computing device in six degrees of freedom, as well as accelerations and rotational velocities, so as to track the rotational and translational motion of the mobile computing device and provide a spatial orientation 58 of the device 12.

As shown in FIG. 1 with reference to FIG. 2A, the inertial measurement units 26A and 26B may also be configured to measure a relative angular orientation 56 of the first and second displays 24A, 24B. As the user applies force to the housing 14 of the mobile computing device 12 to rotate the first and second displays 24A, 24B around the hinge 36, the inertial measurement units 26A and 26B will detect the resulting movement. Thus, based on inertial measurement unit data for a new rotation and a previously known angular orientation between the first and second displays 24A, 24B, the orientation module 42 may calculate a new relative angular orientation 56 resulting after the user rotates the first and second displays 24A, 24B. It will be appreciated that the relative angular orientation 56 may also be calculated via other suitable methods. For example, the sensor devices 20 may further include an angle sensor 36A in the hinge 36 that is configured to detect an angular orientation of the hinge 36, and thereby detect a relative angular orientation 56 of the first and second displays 24A, 24B around the pivot which is the hinge 36. In this embodiment, the angle sensor 36A is incorporated within the hinge 36 itself. However, it will be appreciated that the angle sensor 36A may alternatively be provided outside of the hinge 36. Additionally or alternatively, the relative angular orientation 56 and/or the spatial orientation 58 of the device 12 may be determined from sensor data 54 received from orientation sensors 26C, 26D. Orientations sensors 26C, 26D, like the other orientation sensors described herein, may include, but are not limited to, accelerometers, and/or gyrometers, and/or compasses, and may be inertial measurement units containing these components in a consolidated package. Further, cameras may use processing techniques to recognize features of captured images in relation to the environment to determine a spatial orientation 58 of the device 12.

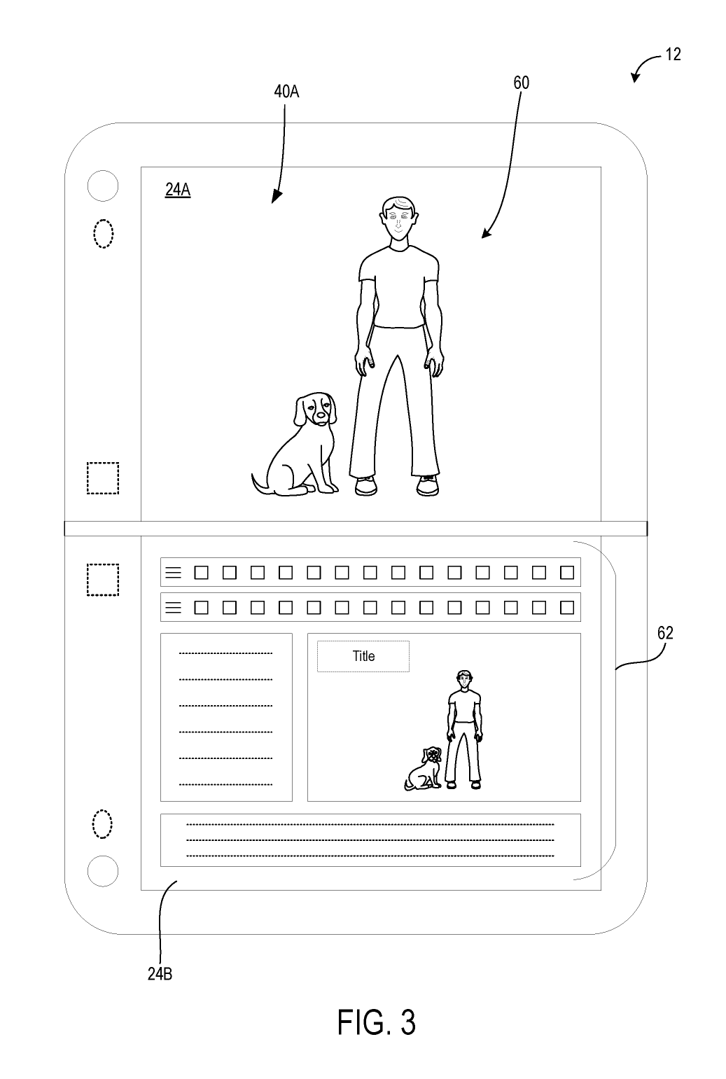

Turning now to FIG. 3, an example implementation of the present disclosure is illustrated. Here, a user may be utilizing the mobile computing device 12 to execute a presentation application program 40A, but it will be appreciated that the type of application program is exemplary and that the present disclosure may be implemented in any suitable application program 40 on a mobile computing device. As shown in FIG. 3, the first and second displays 24A, 24B may be arranged in an open, top-to-bottom orientation. In these angular and spatial orientations, the first display 24A may be configured to display a preview 60 of a presentation, and the second display 24B may be configured to display an editing module 62 for the presentation. As such, a user may easily and conveniently view his or her presentation on the first display 24A of the mobile computing device 12 while concurrently editing its content on the second display 24B.

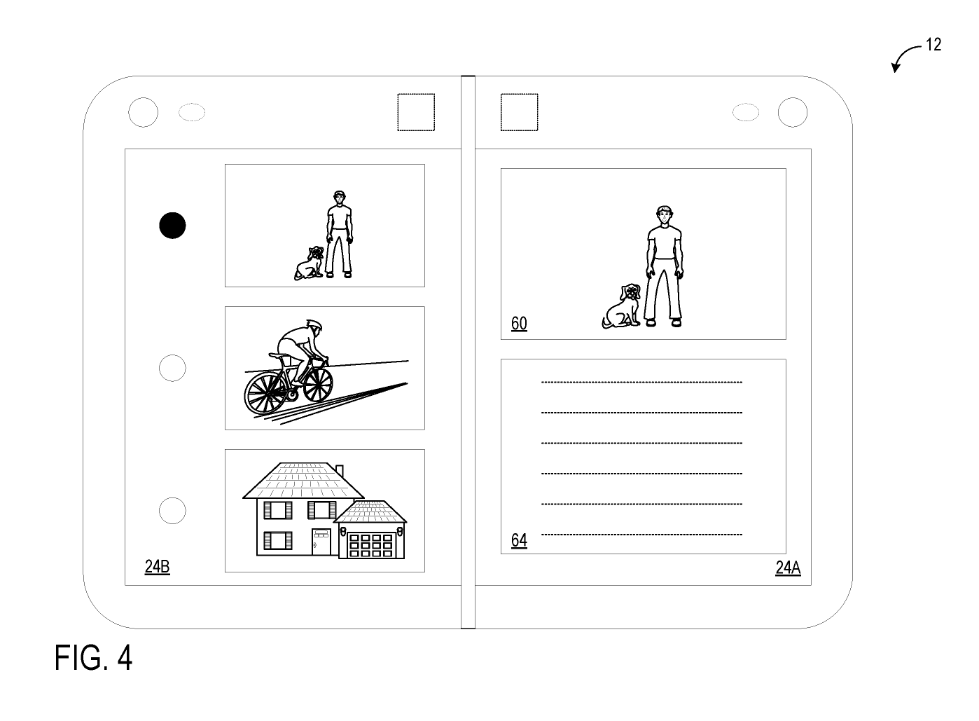

FIG. 4 provides an example implementation of the present disclosure in which the first and second displays 24A, 24B of the mobile computing device 12 are arranged in an open, side-by-side orientation. In these angular and spatial orientations, the first display 24A is configured to display a preview 60 of a selected slide and presenter information 64, such as notes, and the second display 24B is configured to display a plurality of slides included in a presentation. This allows a user to review a presentation and his or her notes on the mobile computing device 12 at the same time. As such, the user may easily edit presentation notes with reference to presentation content in previous, current, and subsequent slides. While the example implementation illustrates the slides in a cascade, it will be appreciated that the slides may be arranged in other suitable formats, such as tile or thumbnail, as provided by the presentation application program 40A.

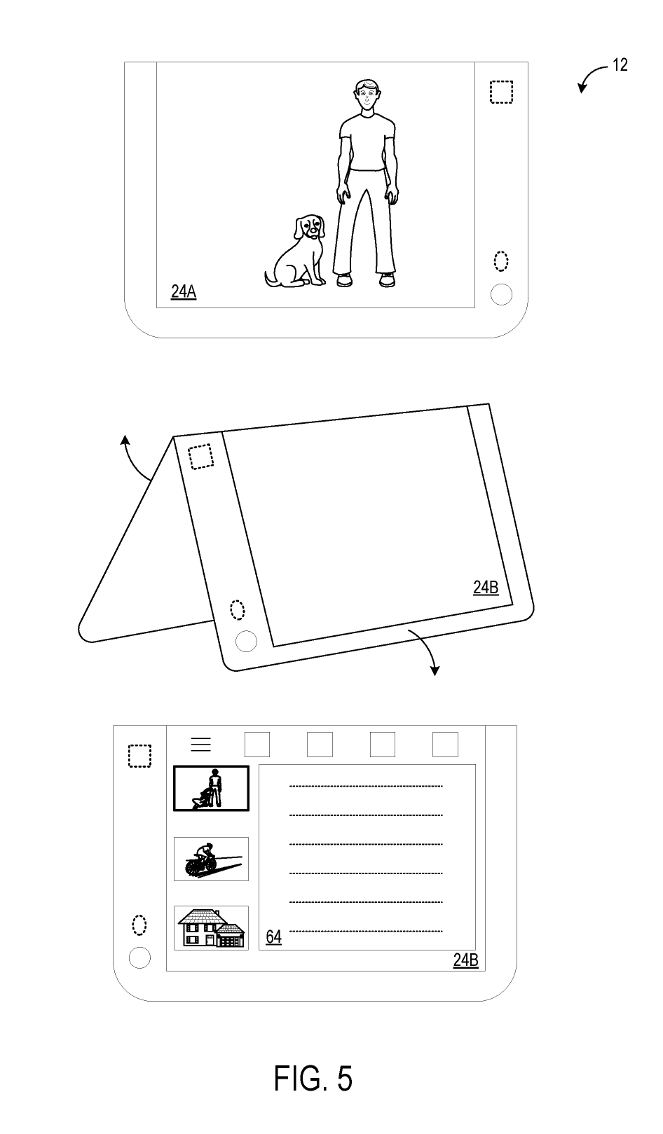

As shown in FIG. 5, a user may rotate the first and second displays 24A, 24B such that the presentation application program 40A is configured to be in a presentation mode when the first display 24A is arranged in a back-to-back orientation with respect to the second display 24B. In this implementation, the first display 24A facing an audience may be configured to display a presentation, and the second display 24B facing a user may be configured to display presenter information 64 (such as presenter notes) to the user. Thus, when using the mobile computing device 12 in a presentation mode, a user may privately view presenter information 64 such as notes and previews of the slideshow while concurrently presenting a slideshow to an audience. In the example implementation, the second display 24B is configured to display presenter information 64 to the user; however, it will be appreciated that the second display 24B may also be utilized to perform other tasks. For example, the user may wish to record notes, edit content, or view a different application program 40 or webpage on the second display 24B while displaying a presentation on the first display 24A. As discussed above, the example implementation illustrates a mobile computing device 12 executing a presentation application program 40A; however, it will be appreciated that content from another suitable type of application program 40A may be displayed to an audience, such as video content or a photo album.

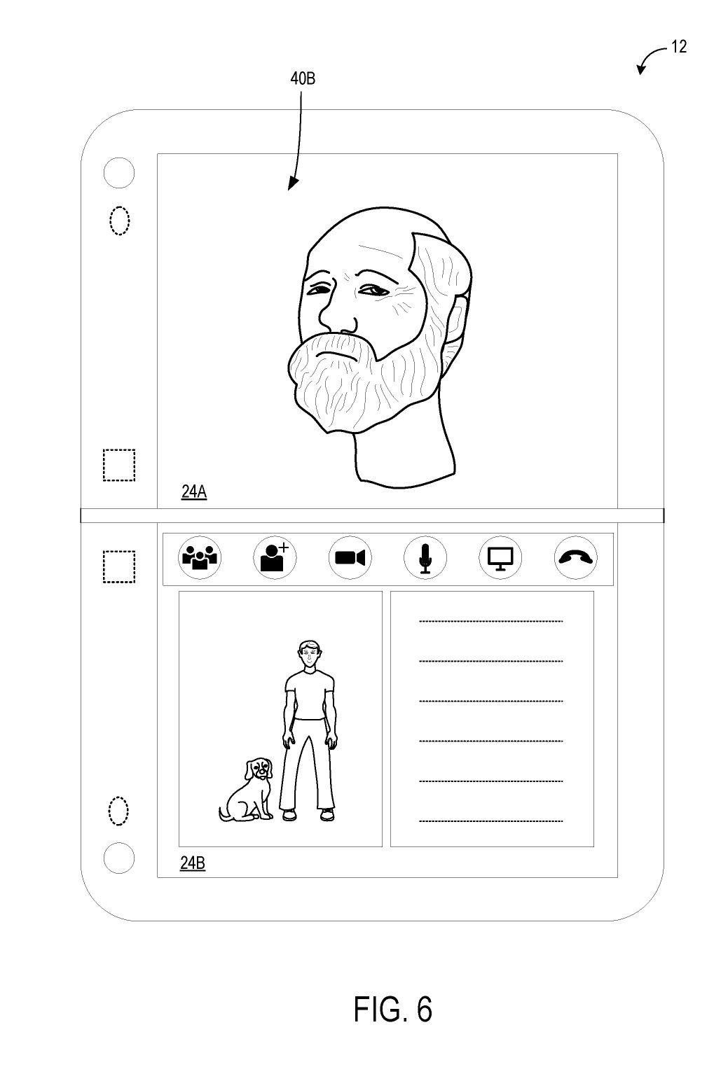

In one implementation, the mobile computing device 12 may be used in the context of a video conference application program 40B to allow a user to maintain visual contact with other members of the video conference on one display while performing a separate task on another display. In an example illustration of this implementation, FIG. 6 shows a configuration of the mobile computing device 12 in which the first and second displays 24A, 24B are arranged in an open, top-to-bottom orientation. While executing a video conference application program 40B in this orientation, the first display 24A is configured to display a video conference, and the second display 24B is configured to display content. This implementation allows a user to participate in the video conference while concurrently taking notes, editing a document, or viewing a different application program 40 or webpage. The user may choose to share the content from the second display with other members of the video conference.

In any of the implementations described herein, a user may switch the mode of an application program 40 on the mobile computing device 12 by changing the angular and spatial orientations of the mobile computing device 12 and the first and second displays 24A, 24B. For example, a user may review presenter information 64 with the mobile computing device 12 in an open, side-by-side orientation prior to delivering a presentation (see FIG. 4), desire to change an aspect of the presentation, and rotate the mobile computing device 12 to an open, top-to-bottom orientation to access the editing module 62 (see FIG. 3). While conventional user input may be used to switch the mode of, for example, presentation application program 40A, it will be appreciated that, according to the present disclosure, a user's intent may be derived from the state of the mobile computing device 12, i.e., the angular and spatial orientations, rather than just direct user input. The orientations provided in this application are exemplary configurations, and it will be appreciated that additional orientations of the mobile computing device 12 not described herein may be implemented to achieve other suitable, desired modes of a presentation application program.

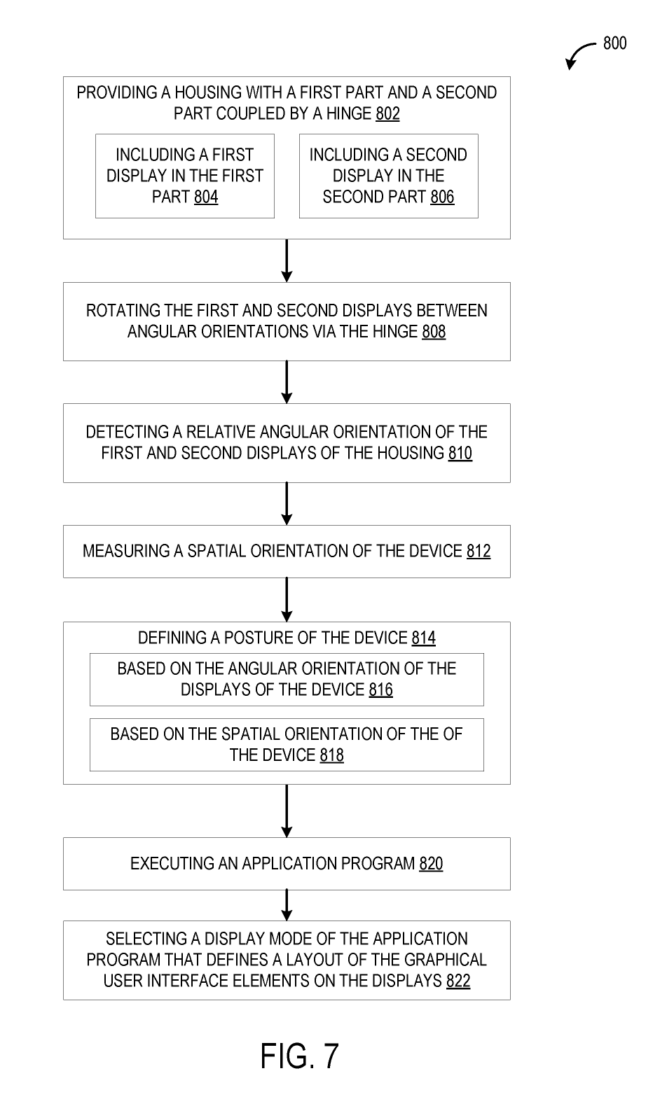

FIG. 7 shows an example method 800 according to an embodiment of the present description. Method 800 may be implemented on the mobile computing device described above or on other suitable computer hardware. At step 802, the method 800 may include providing a housing having a first part and a second part coupled by a hinge. As shown at steps 804 and 806, the method may further comprise including a first display in the first part and including a second display in the second part.

Continuing from step 802 to step 808, the method may include rotating the first and second displays between angular orientations via the hinge. As discussed above, the first and second displays may rotate around the hinge in a range from a face-to-face angular orientation to a back-to-back angular orientation.

Continuing from step 808 to step 810, the method may include detecting a relative angular orientation of the first and second displays of the housing. As discussed above, the first and second displays are included in the first and second parts of the housing, which may be rotated around the hinge, and data from sensor devices such as the angle sensor discussed above may provide the relative angular orientation of the first and second displays of the housing in relation to one another to determine a device function or processing capability.

Proceeding from step 810 to step 812, the method may include measuring a spatial orientation of the device. As discussed above, sensor devices such as inertial measurement units included in the mobile computing device may be configured to measure the position of the mobile computing device in six degrees of freedom, as well as accelerations and rotational velocities, so as to track the rotational and translational motion of the mobile computing device and provide a spatial orientation of the device. At step 814, the method may include defining a posture of the device based on one or both of the angular orientation of the displays of the device (see 816) and/or the spatial orientation (see 818) of the device. The processor may process input from sensor devices such as the angle sensor and/or inertial measurement units to determine the angular orientation of the displays and the spatial orientation of the device.

Continuing to step 820, the method may include executing an application program. As discussed above, the processor may be configured to execute an application program on the mobile computing device.

Continuing to step 822, the method may include selecting a display mode of the application program from a plurality of display modes. As described above, each display mode is determined by the posture of the device and may define a layout of graphical user interface elements of the application program on the first and second displays. The mobile computing device may be configured to display an application program in one display mode according to one posture of the device and switch the display mode of the application program when the device is arranged in a different posture. The display mode of the application program may be determined by the angular orientation of the displays or the spatial orientation of the device, and a change in either or both of these orientations may trigger a change in the display mode of the application program. Thus, in step 822 of the method, the display mode of the application program may be changed based on the angular orientation of the first and second displays, as shown at step 816, and/or based on the spatial orientation of the device, as shown at step 818.

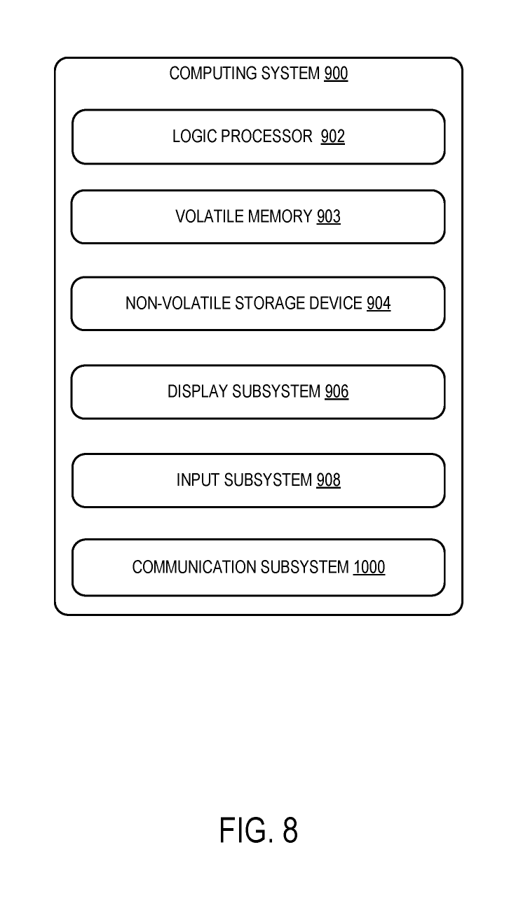

FIG. 8 schematically shows a non-limiting embodiment of a computing system 900 that can enact one or more of the methods and processes described above. Computing system 900 is shown in simplified form. Computing system 900 may embody the mobile computing device 12 of FIG. 1. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 903, and a non-volatile storage device 904. Computing system 900 may optionally include a display subsystem 906, input subsystem 908, communication subsystem 1000, and/or other components not shown in FIG. 8.

Logic processor 902 includes one or more physical devices configured to execute instructions. For example, the logic processor may be configured to execute instructions that are part of one or more application programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 904 includes one or more physical devices configured to hold instructions executable by the logic processors to implement the methods and processes described herein. When such methods and processes are implemented, the state of non-volatile storage device 904 may be transformed—e.g., to hold different data.

Non-volatile storage device 904 may include physical devices that are removable and/or built-in. Non-volatile storage device 904 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 904 may include nonvolatile, dynamic, static, read/write, read-only, sequential-access, location-addressable, file-addressable, and/or content-addressable devices. It will be appreciated that non-volatile storage device 904 is configured to hold instructions even when power is cut to the non-volatile storage device 904.

Volatile memory 903 may include physical devices that include random access memory. Volatile memory 903 is typically utilized by logic processor 902 to temporarily store information during processing of software instructions. It will be appreciated that volatile memory 903 typically does not continue to store instructions when power is cut to the volatile memory 903.

Aspects of logic processor 902, volatile memory 903, and non-volatile storage device 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 904, using portions of volatile memory 903. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by non-volatile storage device 904. The visual representation may take the form of a graphical user interface (GUI). As the herein described methods and processes change the data held by the non-volatile storage device, and thus transform the state of the non-volatile storage device, the state of display subsystem 906 may likewise be transformed to visually represent changes in the underlying data. Display subsystem 906 may include one or more display devices utilizing virtually any type of technology. Such display devices may be combined with logic processor 902, volatile memory 903, and/or non-volatile storage device 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1000 may be configured to communicatively couple various computing devices described herein with each other, and with other devices. Communication subsystem 1000 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet.

The following paragraphs provide additional support for the claims of the subject application. One aspect provides a mobile computing device comprising a housing having a first part and a second part coupled by a hinge, an angle sensor mounted in the housing, one or more inertial measurement units mounted in the housing, and a processor mounted in the housing. The first part may include a first display, and the second part may include a second display. The hinge may be configured to permit the first and second displays to rotate between angular orientations. The angle sensor may be configured to detect a relative angular orientation of the first and second displays of the housing. The one or more inertial measurement units may be configured to measure a spatial orientation of the device. The processor may be configured to execute an application program. The angular orientation of the first and second displays of the housing and the spatial orientation of the device may define a posture of the device. Based upon the posture of the device, the processor may be configured to select a display mode of the application program from a plurality of display modes, and each display mode may define a layout of graphical user interface elements of the application program on the first and second displays.

In this aspect, additionally or alternatively, the angular orientation of the first and second displays of the housing may be in a range from a face-to-face angular orientation to a back-to-back angular orientation. In this aspect, additionally or alternatively, graphical user interface elements corresponding to a first view of the application program may be displayed on the first display, and graphical user interface elements corresponding to a second view of the application program may be displayed on the second display. In this aspect, additionally or alternatively, an application programming interface may be configured to determine a posture-specific display mode selection of the application program. In this aspect, additionally or alternatively, the first and second displays may be arranged in an open, top-to-bottom orientation in which the first display may be configured to display a preview of a presentation, and the second display may be configured to display an editing module for the presentation. In this aspect, additionally or alternatively, the first and second displays may be arranged in an open, side-by-side orientation in which the first display may be configured to display a preview of a selected slide and presenter information, and the second display may be configured to display a plurality of slides included in a presentation. In this aspect, additionally or alternatively, the application program may be configured to be in a presentation mode when the first display is arranged in a reflex, back-to-back orientation with respect to the second display. In this aspect, additionally or alternatively, the first display facing an audience may be configured to display a presentation, and the second display facing a user may be configured to display presenter information to the user. In this aspect, additionally or alternatively, the first and second displays may be arranged in an open, top-to-bottom orientation in which the first display may be configured to display a video conference, and the second display may be configured to display other content. In this aspect, additionally or alternatively, the relative angular displacement may be measured between an emissive side of each of the first and second displays, and a face-to-face angular orientation may be defined to be between 0 degrees and 90 degrees, an open angular orientation may be defined to be between 90 degrees and 270 degrees, and a back-to-back angular orientation may be defined to be between 270 degrees and 360 degrees.

Another aspect provides a method for a mobile computing device. The method includes providing a housing having a first part and a second part rotatably coupled by a hinge, the first part including a first display and the second part including a second display. The method further includes detecting a relative angular orientation of the first and second displays of the housing via an angle sensor mounted in the housing, and measuring a spatial orientation of the device via one or more inertial measurement units mounted in the housing. The angular orientation of the first and second displays of the housing and the spatial orientation of the device may define a posture of the device. The method further includes executing an application program via a processor mounted in the housing, and, based upon the posture of the device, selecting a display mode of the application program from a plurality of display modes. Each display mode may define a layout of graphical user interface elements of the application program on the first and second displays.

In this aspect, additionally or alternatively, the method may further comprise displaying graphical user interface elements corresponding to a first view of the application program on the first display, and displaying graphical user interface elements corresponding to a second view of the application program on the second display. In this aspect, additionally or alternatively, the method may further comprise configuring an application programming interface to determine a posture-specific display mode selection of the application program. In this aspect, additionally or alternatively, the method may further comprise arranging the first and second displays in an open, top-to-bottom orientation, configuring the first display to display a preview of a presentation, and configuring the second display to display an editing module for the presentation. In this aspect, additionally or alternatively, the method may further comprise arranging the first and second displays in an open, side-by-side orientation, configuring the first display to display a preview of a selected slide and presenter information, and configuring the second display to display a plurality of slides included in a presentation. In this aspect, additionally or alternatively, the method may further comprise configuring the application program to be in a presentation mode when the first display is arranged in a reflex, back-to-back orientation with respect to the second display. In this aspect, additionally or alternatively, the method may further comprise configuring the first display facing an audience to display a presentation, and configuring the second display facing a user to display presenter information to the user. In this aspect, additionally or alternatively, the method may further comprise arranging the first and second displays in an open, top-to-bottom orientation, configuring the first display to display a video conference, and configuring the second display to display other content.

Another aspect provides a mobile computing device comprising a housing having a first part and a second part coupled by a hinge, a pair of orientation sensors mounted in the housing, and a processor mounted in the housing. The first part may include a first display, and the second part may include a second display. The hinge may be configured to permit the first and second displays to rotate between angular orientations from a face-to-face angular orientation to a back-to-back angular orientation. The pair of inertial measurement units may be configured to measure a spatial orientation of the device as well an angular orientation of the first and second displays of the housing. The processor may be configured to execute an application program, and a display mode of the application program may be changed based on the angular orientation of the first and second displays of the housing and the spatial orientation of the device. In this aspect, additionally or alternatively, the orientation sensors may be inertial measurement units.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A mobile computing device comprising:
a housing having a first part and a second part coupled by a hinge, the first part including a first display and the second part including a second display, wherein the hinge is configured to permit the first and second displays to rotate between angular orientations;
an angle sensor mounted in the housing and configured to detect a relative angular orientation of the first and second displays of the housing;
one or more inertial measurement units mounted in the housing and configured to measure a spatial orientation of the device; and
a processor mounted in the housing, the processor being configured to execute an application program, wherein
the angular orientation of the first and second displays of the housing and the spatial orientation of the device define a posture of the device, and
based upon the posture of the device, the processor is configured to select a display mode of the application program from a plurality of display modes, each display mode defining a layout of graphical user interface elements of the application program on the first and second displays.

2. The mobile computing device according to claim 1, wherein
the angular orientation of the first and second displays of the housing is in a range from a face-to-face angular orientation to a back-to-back angular orientation.

3. The mobile computing device according to claim 1, wherein
graphical user interface elements corresponding to a first view of the application program are displayed on the first display, and graphical user interface elements corresponding to a second view of the application program are displayed on the second display.

4. The mobile computing device according to claim 1, wherein
an application programming interface is configured to determine a posture-specific display mode selection of the application program.

5. The mobile computing device according to claim 1, wherein
the first and second displays are arranged in an open, top-to-bottom orientation; and
the first display is configured to display a preview of a presentation, and the second display is configured to display an editing module for the presentation.

6. The mobile computing device according to claim 1, wherein
the first and second displays are arranged in an open, side-by-side orientation; and
the first display is configured to display a preview of a selected slide and presenter information, and the second display is configured to display a plurality of slides included in a presentation.

7. The mobile computing device according to claim 1, wherein
the application program is configured to be in a presentation mode when the first display is arranged in a reflex, back-to-back orientation with respect to the second display.

8. The mobile computing device according to claim 6, wherein
the first display facing an audience is configured to display a presentation, and
the second display facing a user is configured to display presenter information to the user.

9. The mobile computing device according to claim 1, wherein
the first and second displays are arranged in an open, top-to-bottom orientation; and
the first display is configured to display a video conference, and the second display is configured to display other content.

10. The mobile computing device of claim 1, wherein
the relative angular displacement is measured between an emissive side of each of the first and second displays; and
a face-to-face angular orientation is defined to be between 0 degrees and 90 degrees;
an open angular orientation is defined to be between 90 degrees and 270 degrees; and
a back-to-back angular orientation is defined to be between 270 degrees and 360 degrees.

11. A method for a mobile computing device, the method comprising:
providing a housing having a first part and a second part rotatably coupled by a hinge, the first part including a first display and the second part including a second display;
detecting a relative angular orientation of the first and second displays of the housing via an angle sensor mounted in the housing;
measuring a spatial orientation of the device via one or more inertial measurement units mounted in the housing, wherein the angular orientation of the first and second displays of the housing and the spatial orientation of the device define a posture of the device;
executing an application program via a processor mounted in the housing;
based upon the posture of the device, selecting a display mode of the application program from a plurality of display modes, each display mode defining a layout of graphical user interface elements of the application program on the first and second displays.

12. The method according to claim 11, the method further comprising:
displaying graphical user interface elements corresponding to a first view of the application program on the first display, and
displaying graphical user interface elements corresponding to a second view of the application program on the second display.

13. The method according to claim 11, the method further comprising:
configuring an application programming interface to determine a posture-specific display mode selection of the application program.

14. The method according to claim 11, the method further comprising:
arranging the first and second displays in an open, top-to-bottom orientation; and
configuring the first display to display a preview of a presentation, and configuring the second display to display an editing module for the presentation.

15. The method according to claim 11, the method further comprising:
arranging the first and second displays in an open, side-by-side orientation; and
configuring the first display to display a preview of a selected slide and presenter information, and configuring the second display to display a plurality of slides included in a presentation.

16. The method according to claim 11, the method further comprising:
configuring the application program to be in a presentation mode when the first display is arranged in a reflex, back-to-back orientation with respect to the second display.

17. The method according to claim 16, the method further comprising:
configuring the first display facing an audience to display a presentation, and
configuring the second display facing a user to display presenter information to the user.

18. The method according to claim 11, the method further comprising:
arranging the first and second displays in an open, top-to-bottom orientation; and
configuring the first display to display a video conference, and configuring the second display to display other content.

19. A mobile computing device comprising:
a housing having a first part and a second part coupled by a hinge, the first part including a first display and the second part including a second display, wherein the hinge is configured to permit the first and second displays to rotate between angular orientations from a face-to-face angular orientation to a back-to-back angular orientation;
a pair of orientation sensors mounted in the housing and configured to measure a spatial orientation of the device as well an angular orientation of the first and second displays of the housing; and
a processor mounted in the housing, the processor being configured to execute an application program, wherein
a display mode of the application program is changed based on the angular orientation of the first and second displays of the housing and the spatial orientation of the device.

20. The mobile computing device of claim 19, wherein
the orientation sensors are inertial measurement units.
